(19) United States
(12) Patent Application Publication
(10) Pub. No.: US 2012/0130760 A1
(43) Pub. Date: May 24, 2012

(54) ADJUSTING A POINT PREDICTION THAT IS PART OF THE LONG-TERM PRODUCT LIFE CYCLE BASED FORECAST

(76) Inventors: Jerry Shan, Palo Alto, CA (US); Jose Luis Beltran, Palo Alto, CA (US); Shailendra K. Jain, Cupertino, CA (US); Alex Zhang, San Jose, CA (US); Ivan Lopez, Mountain View, CA (US)

(21) Appl. No.: 13/386,486

(22) PCT Filed: Oct. 26, 2009
(86) PCT No.: PCT/US2009/062081

§ 371 Date: Jan. 23, 2012

(51) Int. Cl. G06Q 10/04

(52) U.S. Cl. 705/7.12; 705/7.31; 705/7.11

(57) ABSTRACT

Illustrated is a system and method for modeling and predicting call center service calls to plan staffing needs based upon historical call center volume data and product life cycle data for the product being serviced by the call center. It includes identifying adjusted historical monthly call volume data. Additionally, the system and method includes transforming the adjusted historical monthly call volume data, using a forecasting algorithm, into a long-term trend and season effect forecast. Further, the system and method includes transforming the adjusted historical monthly call volume data, using a regression algorithm, into a long-term product life cycle based forecast. Additionally, the system and method includes adjusting a point prediction, based on the long-term product life cycle based forecast to create a long-term adjusted monthly forecast, the point prediction adjusted where it exceeds a data point in a bound forecast generated from the long-term trend and season effect forecast.

### BACKGROUND

The quality of workforce planning or staffing and scheduling for a call center depends significantly on the understanding and forecasting of the call volumes received at the call center. The call volumes can change significantly from one hour to the next or from one day to the next. These changes may be based upon peak business periods, or lulls in business activity due to, for example, holidays. Further, the life cycles of the products being serviced by the call center may also affect call center activity.

### BRIEF DESCRIPTION OF THE DRAWINGS

Some embodiments of the invention are described, by way of example, with respect to the following figures:

FIG. 1 is a diagram of a system, according to an example embodiment, to determine call center staffing needs through the use of a long-term adjusted monthly forecast.

FIG. 2 is a rectangular coordinate system graph, according to an example embodiment, illustrating workforce staffing needs for a calendar month.

FIG. 3 is a rectangular coordinate system graph, according to an example embodiment, illustrating a call volume relative to a product life cycle.

FIG. 4 is a rectangular coordinate system graph, according to an example embodiment, illustrating a bounded long-term product life cycle effect.

FIG. 5 is a block diagram of a computer system, according to an example embodiment, used to create a long-term adjusted monthly forecast.

FIG. 6 is a block diagram of a computer system, according to an example embodiment, used to generate a call center service schedule based upon a derivation of the long-term adjusted monthly forecast.

FIG. 7 is a block diagram of a computer system, according to an example embodiment, used to create a long-term adjusted monthly forecast.

FIG. 8 is a flow chart of a method, according to an example embodiment, used to create a long-term adjusted monthly forecast.

FIG. 9 is a flow chart of a method, according to an example embodiment, used to generate a call center service schedule based upon a derivation of the long-term adjusted monthly forecast.

FIG. 10 is a flow chart of a method, according to an example embodiment, used to create a long-term adjusted monthly forecast.

FIG. 11 is a flow chart illustrating a method, according to an example embodiment, used to build a long-term adjusted monthly forecast.

FIG. 12 is a flow chart illustrating a method, according to an example embodiment, to identify and quantify long-terms effects.

FIG. 13 is a flow chart illustrating a method, according to an example embodiment, to process the adjusted historical monthly data to generate a monthly forecast.

FIG. 14 is a flow chart illustrating a method, according to an example embodiment, to use regression to determine a long-term product life cycle effect based forecast for the call center volumes.

FIG. 15 is a flow chart illustrating a method, according to an example embodiment, for applying the long-term adjusted monthly forecast based upon some type of time granular basis.

FIG. 16 is a flow chart illustrating a method, according to an example embodiment, for aggregating and identifying data for use in forecasting call center volumes using the long-term adjusted monthly forecast.

FIG. 17 is a flow chart illustrating a method, according to an example embodiment, to forecast a future month call center volume on an unadjusted basis.

FIG. 18 is a flow chart illustrating a method, according to an example embodiment, to forecast the historical norm call center volume for a day in a week.

FIG. 19 is a flow chart illustrating a method, according to an example embodiment, used to forecast call center volume for a future period of days.

FIG. 20 is a diagram of a computer system, according to an example embodiment.

### DETAILED DESCRIPTION

Illustrated is a system and method for modeling and predicting call center service calls to plan staffing needs based upon historical call center volume data and product life cycle data for the product being serviced by the call center. In one example embodiment, a forecast model is generated that can forecast call center volumes for future periods including hours, day, weeks, and months. Using these forecasts, long-term and short-term workforce planning can be engaged in by a call center manager using a device that implements the system and method illustrated herein. Workforce planning, as used herein, includes determining the number of the employees needed to meet a forecasted call center volume for a particular time period.

In one example embodiment, a long-term adjusted monthly forecast is generated that is based, in part, upon a product life cycle and its relationship to call center volumes over a defined period of time. The generation of this forecast includes aggregating monthly call center volume data and adjusting this data for non-work week days. Non-work week days include holidays, weekends (e.g., Saturday or Sunday), or other off work days. This monthly, adjusted call center volume data is used to create an adjusted monthly forecast reflecting potential call center volume for future months. Additionally, the generation of the long-term adjusted monthly forecast also includes performing a regression analysis on the monthly call center volume as it relates to particular products. A product, as used herein, is a good or service that is sold in commerce. The result of this regression analysis is used to provide bounds (e.g., an upper and lower bound) for an adjusted monthly forecast to create a long-term adjusted monthly forecast. These upper and lower bounds may be generated through a confidence interval forecast, or a manually adjusted range forecast.

In some example embodiments, the intraday (e.g. half-hourly) forecast along with the long-term adjusted monthly forecast are used to generate a call center service schedule that is used in call center workforce planning. Specifically, through the use of the long-term adjusted monthly forecast, workforce needs for a future month, day, hour, or fiscal period can be planned through an optimization engine. Further, the long-term adjusted monthly forecast can be used as input for the planning of call center staffing needs. Additionally, historical norms for a particular day in a week can be determined. The various systems and methods for predicting center staffing needs based upon historical call center volume data and product life cycle data for the product being serviced by the call center are outlined below.

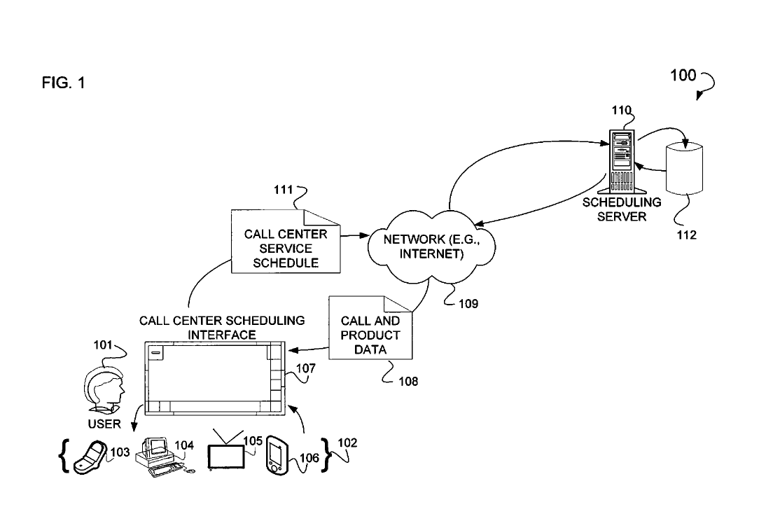

FIG. 1 is a diagram of an example system 100 to determine call center staffing needs through the use of a long-term adjusted monthly forecast. Shown is a user 101 who uses a call center scheduling interface 107 to initiate the generation of a call center service schedule 111. The user 101 may be a call center manager, or other suitable individual. The call center scheduling interface 107 may be a Graphical User Interface (GUI), a command line interface, or other suitable type of interface. This call center scheduling interface 107 may be generated by one or more of the device 102. These devices 102 include a cell phone 103, computer system 104, television or monitor 105, or smart phone 106. In one example embodiment, call and product data 108 is retrieved from a scheduling server 110 that is operatively connected to a data base 112 via a network 109. The call and product data 108 may include aggregated call volume data and/or aggregated adjusted call volume data. Further, the call and product data 108 may include product life cycle data. Operatively connected, as used herein, includes a physical or logical connection. Using the systems and methods outlined below, this call and product data 108 is used to generate the call center service schedule 111. This call center service schedule 111 includes workforce planning that is generated through the use of the below outlined system and method. This call center service schedule 111 is transmitted across the network 109 to the scheduling server 110 to be stored into the database 112. In some example embodiments, the call center service schedule 111 is generated by the scheduling server 110 using the systems and method illustrated herein.

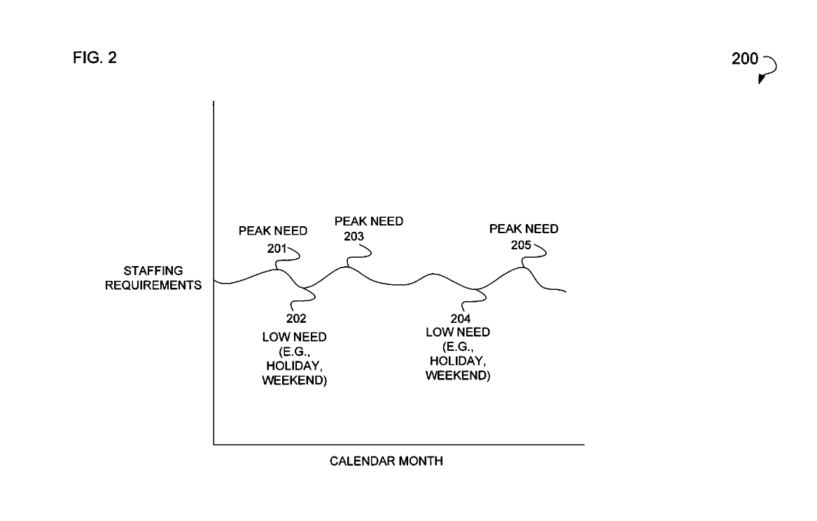

FIG. 2 is a rectangular coordinate system graph 200 illustrating the example workforce staffing needs for a calendar month. As illustrated, workforce staffing needs may peak during certain period of a calendar month. These peak periods, referenced at 201, 203, and 205, may include work days or other times when a call center may experience high call volume. Additionally, as illustrated, work force staffing needs may experience a low during certain periods of the calendar month. These periods of low need, referenced at 202 and 204, may correspond to holidays, weekends, or other periods where a call center may experience low call volume. As will be described in more detail below, forecasting models can be adjusted to remove or decrease in importance the periods of low need 202 and 204. In some example embodiments, the magnitude of variation of these peaks with respect to average volume are used to balance the cost of changing staffing levels with that of hiring and training internally staff to buffer the peak periods.

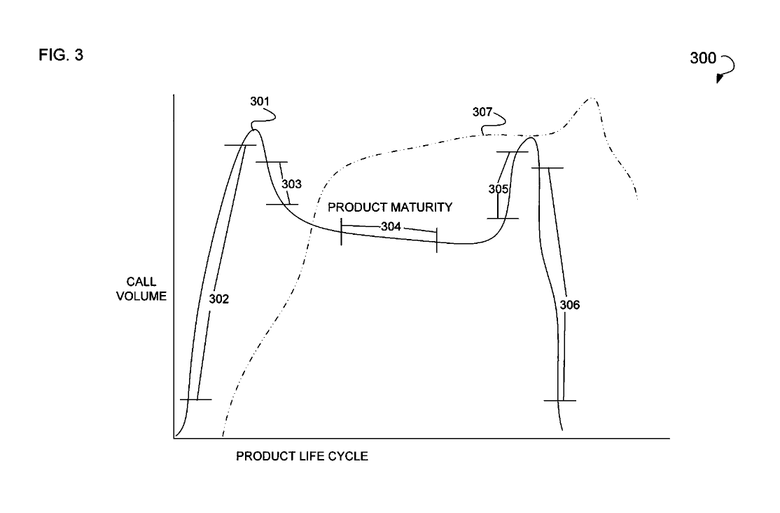

FIG. 3 is a rectangular coordinate system graph 300 illustrating an example call volume relative to a product life cycle. As shown at 302, call center volume increases very rapidly as product ramp up occurs (e.g., sales of a product begins), peaking at 301. As illustrated at 303, call center volume may decline as sales level off. Further, call center volume may be flat as a product matures, as referenced at 304. Moreover, call center volume may increase, as referenced at 305, where sale discounts on the product are provided towards the end of the product's life cycle. Lastly, call center volume may decrease where product ramp down occurs (see reference 306) and sales of the product are ended. Also shown is a curve 307 representing call volume. As illustrated, call center volume may be offset in time (e.g., trail in time) from the product life cycle curve such the volume may increase, for example, after ramp up. Further, as illustrated, this call center volume may follow to some extent the product life cycle.

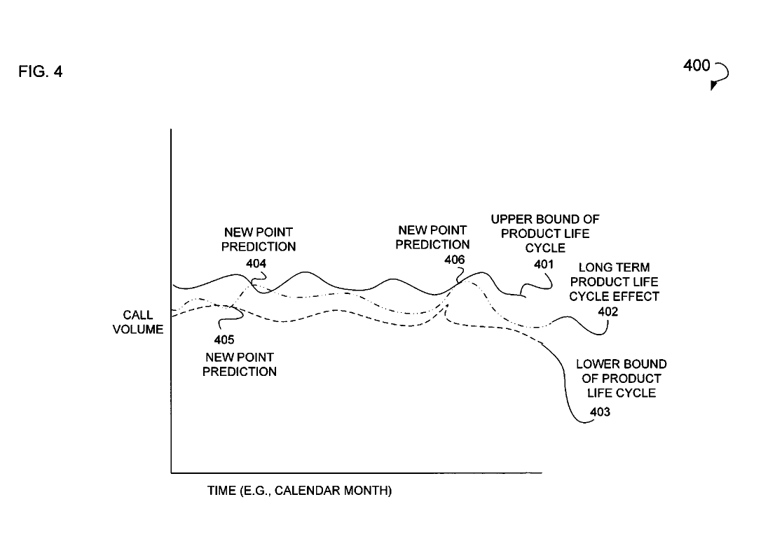

FIG. 4 is a rectangular coordinate system graph 400 illustrating an example bounded long-term product life cycle effect. Shown is a curve representing a long-term product life cycle effect 402. This curve is bounded by a curve in the form of upper bound of product life cycle effect 401, and a curve in the form of lower bound of product life cycle effect 403. The system and method for generating the data for each of these curves is outlined below. Also shown are new prediction points 404-405. A new prediction point, as used herein, is a data point that is part of the long-term product life cycle effect that exceeds the data points that make up the upper or lower bounds (e.g., 401 or 403). As will be more fully discussed below, where a new prediction point exists, the data point(s) that makes up the new prediction point will be adjusted so as to not exceed the upper or lower bounds.

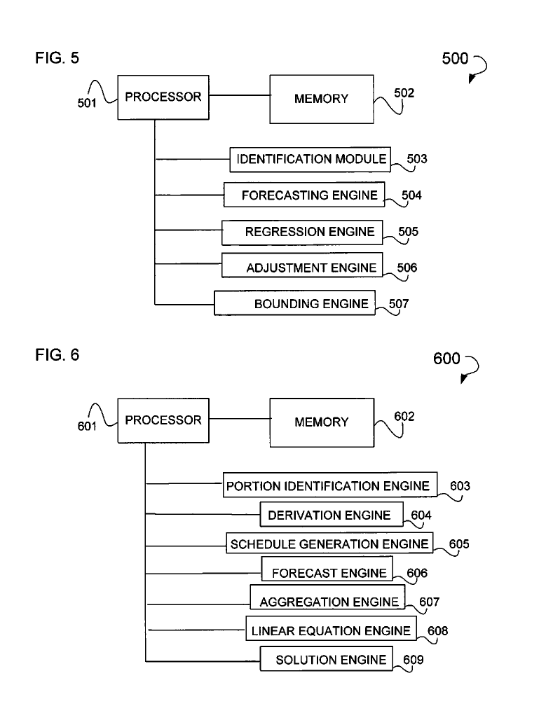

FIG. 5 is a block diagram of an example computer system 500 used to create a long-term adjusted monthly forecast. These various blocks may be implemented in hardware, firmware, or software as part of one or more of the devices 102, or the scheduling server 110. Further, these various blocks are operatively connected. Illustrated is a processor 501 operatively connected to a memory 502. Operatively connected to the processor 501, is a data identification module 503 identifies adjusted historical monthly call volume data. Operatively connected to the processor 501 is a forecasting engine 504 that transforms the adjusted historical monthly call volume data, using a forecasting algorithm, into a long-term trend and season effect forecast. Operatively connected to the processor 501 is a regression engine 505 that implements an algorithm that transforms the adjusted historical monthly call volume data, using a regression algorithm, into a long-term product life cycle based forecast. Operatively connected to the processor 501 is a adjustment engine 506 that adjusts a point prediction, based on the long-term product life cycle based forecast to create a long-term adjusted monthly forecast, the point prediction adjusted where it exceeds a data point in a bound forecast generated from the long-term trend and season effect forecast. In some example embodiments, the adjusted historical monthly call volume data is a date data adjusted to exclude call volume data associated with a non-work day. In some example embodiments, the forecasting algorithm is a Holt-Winters algorithm or an Autoregressive Integrated Moving Average (ARIMA) model. In some example embodiments, the transforming of the adjusted historical monthly call volume data, using a regression algorithm, includes a use of at least one of a sales amount for a product, or a life cycle for the product. Further, in some example embodiments, the regression algorithm includes at least one of a linear regression algorithm or ordinary least squares regression algorithm. In some example embodiments, the bound forecast includes at least one of an upper bound, or lower bound for the long-term product life cycle based forecast. A bounding engine 507 is operatively connected to the processor 501 to generate the upper bound and lower bound using at least one of a confidence interval forecast, or a manually adjusted range forecast.

FIG. 6 is a block diagram of an example computer system 600 used to generate a call center service schedule based upon a derivation of the long-term adjusted monthly forecast. These various blocks may be implemented in hardware, firmware, or software as part of one or more of the devices 102, or the scheduling server 110. Further, these various blocks are operatively connected. Illustrated is a processor 601 operatively connected to a memory 602. Operatively connected to the processor 601 is a portion identification engine 603 to identify a portion of a long-term adjusted monthly forecast based upon a period. A derivation engine 604 is also operatively connected to the processor 601 to determine a derivation of the long-term adjusted monthly forecast based upon the period. A schedule generation engine 605 is operatively connected to the processor 601 to generate a call center service schedule based upon the derivation of the long-term adjusted monthly forecast based upon the period. In some example embodiments, the period includes at least one of a month, a day, an hour, a portion of an hour, or a fiscal period. Further, in some example embodiments, the derivation is a probability distribution of call volume percentages for the period. A forecast engine 606 is operatively connected to the processor 601 to forecast a call volume for the period through dividing the long-term adjusted monthly forecast by a monthly day adjustment ratio for a future period. An aggregation engine 607 is operatively connected to the processor 601 to aggregate call volume data for the period. A linear equation engine 608 is operatively connected to the processor 601 to build a set of linear equations for a portion of the period. A solution engine 609 is operatively connected to the processor 601 to solve the linear equations to get the daily call volume for the portion of the period. In some example embodiments, the period includes at least one of a month, a day, an hour, a portion of an hour, or a fiscal period. In some example embodiments, the portion of the period includes at least one of a day of a month, an hour of a day, or a fiscal period. As used herein, a fiscal period is a period (e.g., monthly, quarterly, or yearly) used for calculating annual financial statements in businesses.

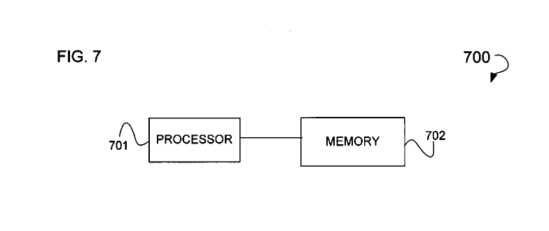

FIG. 7 is a block diagram of an example computer system 700 used to create a long-term adjusted monthly forecast. These various blocks may be implemented in hardware, firmware, or software as part of one or more of the device 102, or the scheduling server 110. Further, these various blocks are operatively connected. Illustrated is a processor 701 operatively connected to a memory 702 that includes logic encoded in one or more tangible media (e.g., computer-readable media) for execution and when executed operable to identify adjusted historical monthly call volume data. Further, the logic encoded in one or more tangible media for execution and when executed operable to transform the adjusted historical monthly call volume data, using a forecasting algorithm, into a long-term trend and season effect forecast. Additionally, logic encoded in one or more tangible media for execution and when executed operable to transform the adjusted historical monthly call volume data, using a regression algorithm, into a long-term product life cycle based forecast. Moreover, the logic encoded in one or more tangible media for execution and when executed operable to adjust a point prediction, based on the long-term product life cycle based forecast to create a long-term adjusted monthly forecast, the point prediction adjusted where it exceeds a data point in a bound forecast generated from the long-term trend and season effect forecast. In some example embodiments, the adjusted historical monthly call volume data is a date data adjusted to exclude call volume data associated with a non-work day. In some example embodiment, the forecasting algorithm is a Holt-Winters algorithm or an ARIMA model. Additionally, in some example embodiments, the transforming of the adjusted historical monthly call volume data, using a regression algorithm, includes a use of at least one of a sales amount for a product, or a life cycle for the product. Further, in some example embodiments, the regression algorithm includes at least one of a linear regression algorithm or ordinary least squares regression algorithm. Moreover, in some example embodiments, the bound forecast includes at least one of an upper bound, or lower bound for the long-term product life cycle based forecast.

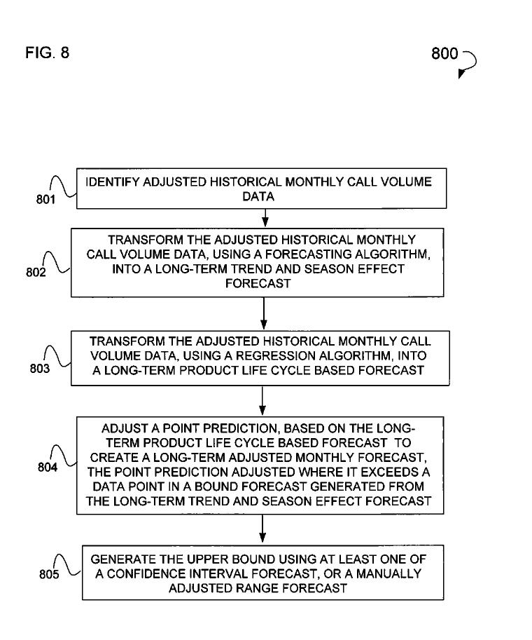

FIG. 8 is a flow chart of an example method 800 used to create a long-term adjusted monthly forecast. This method may be executed by one or more of the device 102, or the scheduling server 110. An operation 801 is executed by the identification module 503 to identify adjusted historical monthly call volume data. Operation 802 is executed by the forecasting engine 504 to transform the adjusted historical monthly call volume data, using a forecasting algorithm, into a long-term trend and season effect forecast. Operation 803 is executed by the regression engine 505 to transform the adjusted historical monthly call volume data, using a regression algorithm, into a long-term product life cycle based forecast. Operation 804 is executed by the adjustment engine 506 to adjust a point prediction, based on the long-term product life cycle based forecast to create a long-term adjusted monthly forecast, the point prediction adjusted where it exceeds a data point in a bound forecast generated from the long-term trend and season effect forecast. In some example embodiments, the adjusted historical monthly call volume data is a date data adjusted to exclude call volume data associated with a non-work day. In some example embodiments, the forecasting algorithm is a Holt-Winters algorithm or an ARIMA model. In some example embodiments, the transforming of the adjusted historical monthly call volume data, using a regression algorithm, includes a use of at least one of a sales amount for a product, or a life cycle for the product. Further, in some example embodiments, the regression algorithm includes at least one of a linear regression algorithm or ordinary least squares regression algorithm. Moreover, in some example embodiments, the bound forecast includes at least one of an upper bound, or lower bound for the long-term product life cycle based forecast. Operation 805 is executed by the bounding engine 507 to generate the upper bound and the lower bound using at least one of a confidence interval forecast, or a manually adjusted range forecast.

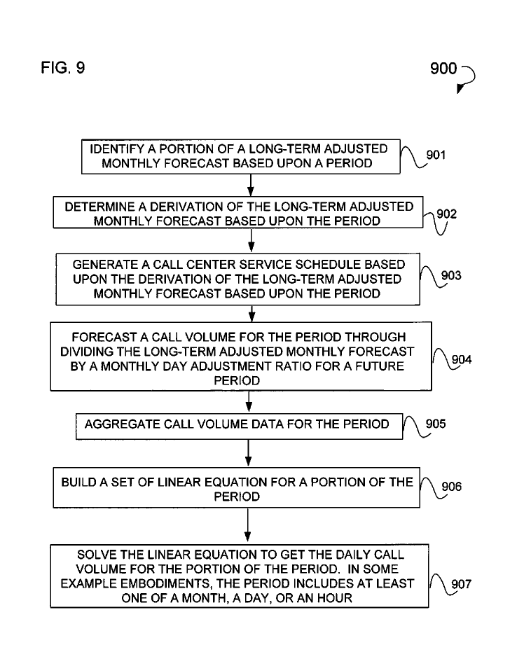

FIG. 9 is a flow chart of an example method 900 used to generate a call center service schedule based upon a derivation of the long-term adjusted monthly forecast. This method may be executed by one or more of the device 102, or the scheduling server 110. An operation 901 is executed by the portion identification engine 603 to identify a portion of a long-term adjusted monthly forecast based upon a period. Operation 902 is executed by the derivation engine 604 to determine a derivation of the long-term adjusted monthly forecast based upon the period. Operation 903 is executed by the schedule generation engine 605 to generate a call center service schedule based upon the derivation of the long-term adjusted monthly forecast based upon the period. In some example embodiments, the period includes at least one of a month, a day, an hour, a portion of an hour, or a fiscal period. In some example embodiments, the derivation is a probability distribution of call volume percentages for the period. Operation 904 is executed by the forecast engine 606 to forecast a call volume for the period through dividing the long-term adjusted monthly forecast by a monthly day adjustment ratio for a future period. Operation 905 is executed by the aggregation engine 607 to aggregate call volume data for the period. Operation 906 is executed by the linear equation engine 608 to build a set of linear equations for a portion of the period. Operation 907 is executed by the solution engine to solve the linear equations to get the daily call volume for the portion of the period. In some example embodiments, the period includes at least one of a month, a day, an hour, a portion of an hour, or a fiscal period. In some example embodiments, the portion of the period includes at least one of a day of a month, or an hour of a day.

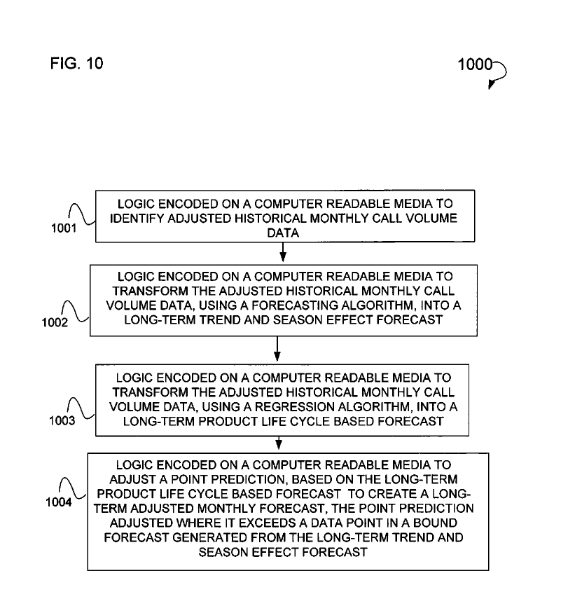

FIG. 10 is a flow chart of an example method 1000 used to create a long-term adjusted monthly forecast. This method may be executed by one or more of the device 102, the scheduling server 110, or included in logic encoded on a computer-readable media associated therewith. An operation 1001 is included in logic encoded on a computer readable media to identify adjusted historical monthly call volume data. An operation 1002 is included in logic encoded on a computer readable media to transform the adjusted historical monthly call volume data, using a forecasting algorithm, into a long-term trend and season effect forecast. Operation 1003 is included in logic encoded on a computer readable media to transform the adjusted historical monthly call volume data, using a regression algorithm, into a long-term product life cycle based forecast. Operation 1004 is included in logic encoded on a computer readable media to adjust a point prediction, based on the long-term product life cycle based forecast to create a long-term adjusted monthly forecast, the point prediction adjusted where it exceeds a data point in a bound forecast generated from the long-term trend and season effect forecast. In some example embodiments, the adjusted historical monthly call volume data is a date data adjusted to exclude call volume data associated with a non-work day. In some example embodiments, the forecasting algorithm is a Holt-Winters algorithm or an ARIMA model. In some example embodiments, the transforming of the adjusted historical monthly call volume data, using a regression algorithm, includes a use of at least one of a sales amount for a product, or a life cycle for the product. In some example embodiments, wherein the regression algorithm includes at least one of a linear regression algorithm or ordinary least squares regression algorithm. In some example embodiments, the bound forecast includes at least one of an upper bound, or lower bound for the long-term product life cycle based forecast.

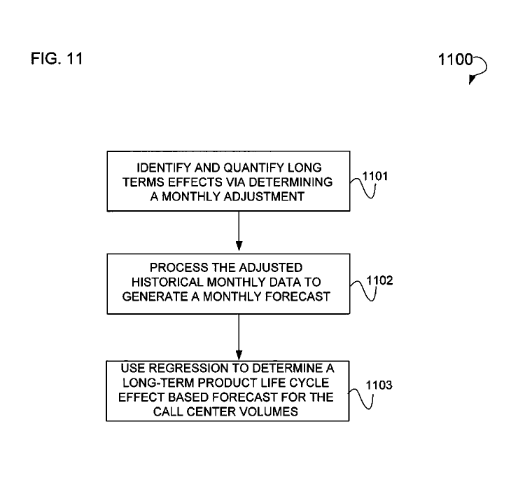

FIG. 11 is a flow chart illustrating an example method 1100 used to build a long-term adjusted monthly forecast. The various operations shown herein may be executed in hardware, software, or firmware. Further, these various operations may be executed by one or more of the devices 102, the scheduling server 110, or included in logic encoded on a computer-readable media associated therewith. Shown is an operation 1101 that is executed to identify and quantify long-terms effects via determining a monthly adjustment. An operation 1103 is executed to process the adjusted historical monthly data to generate a monthly forecast. Operation 1103 is executed to use regression to determine a long-term product life cycle effect based forecast for call center volumes.

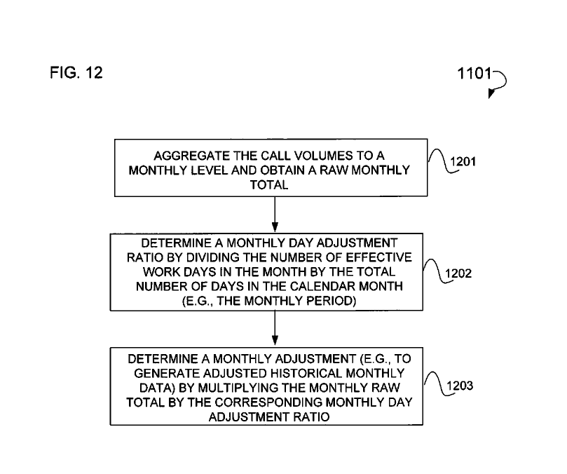

FIG. 12 is a flow chart illustrating an example method 1101 to identify and quantify long-terms effects. Illustrated is an operation 1201 that is executed to aggregate the call volumes to a monthly level and obtain a raw monthly total. In some example embodiments, the call volume data may exist at a very low granularity (e.g., hourly call volume) such that this data is aggregated into a monthly period. Operation 1202 is executed to determine a monthly day adjustment ratio by dividing the number of effective work days in the month by the total number of days in the calendar month (e.g., the monthly period). In some example embodiments, the effective work days in a month exclude the holidays either at the call origination (e.g., the United States) or at the call center (e.g., India). Further, the effective work days may also exclude any other non-work days at a call center (e.g., off-work weekends and work site closure days). Additionally, the monthly day adjustment ratio may change from month to month. In some example embodiments, when computing the ratio for a future month, a planned effective work day is used in place of the actual effective work days. Operation 1203 is executed to determine a monthly adjustment (e.g., to generate adjusted historical monthly data) by multiplying the monthly raw total by the corresponding monthly day adjustment ratio.

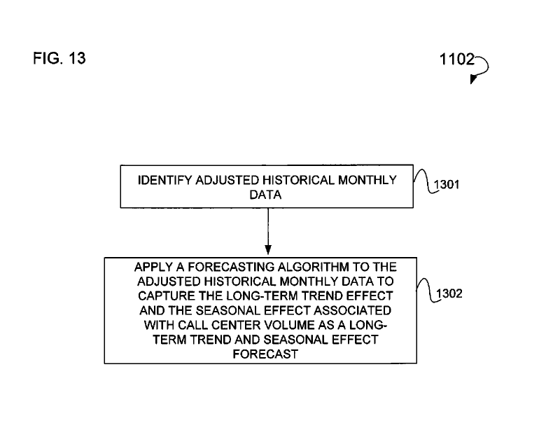

FIG. 13 is a flow chart illustrating an example method 1102 to process the adjusted historical monthly data to generate a monthly forecast. Operation 1301 is executed to identify adjusted historical monthly data. Operation 1302 is executed to apply a forecasting algorithm to the adjusted historical monthly data. As used herein, a forecasting algorithm is an algorithm that uses a model of past events (e.g., past call center volume) to forecast future events (e.g., future call center volume). Example forecasting algorithms include the Holt-Winters algorithm, or an ARIMA model. In one example embodiment, the Holt-Winters algorithm or seasonal ARIMA model represents the long-term trend effect and the seasonal effect associated with call center volume as a long-term trend and seasonal effect forecast.

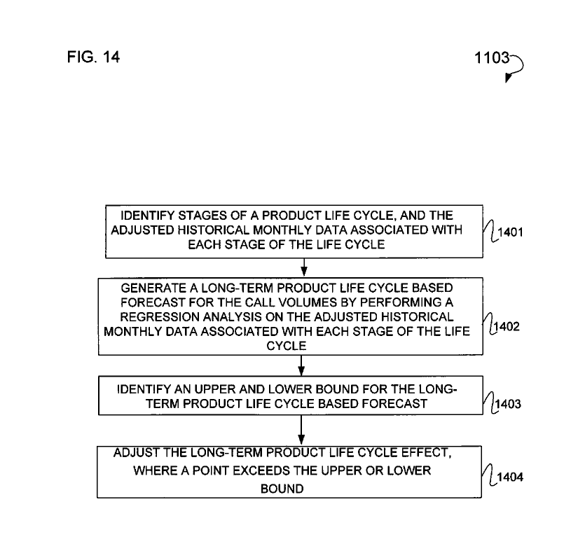

FIG. 14 is a flow chart illustrating an example method 1103 to use regression to determine a long-term product life cycle effect based forecast for the call center volumes. Operation 1401 is executed to identify stages of a product life cycle, and the adjusted historical monthly data associated with each stage of the life cycle. As previously illustrated, these stages may include product ramp up, product maturity, and product ramp down. Operation 1402 is executed to generate a long-term product life cycle based forecast for the call volumes. This forecast is generated by performing a regression analysis on the adjusted historical monthly data associated with each stage of the life cycle. The regression analysis may include the use of linear regression or ordinary least squares regression. In some example embodiments, the sales of the product may be used as in indicator of the stage of the life cycle. The relationship between call volume and sales may be represented as follows:

$${V}_{C}^{( t )} C + {\sum }_{s \leq t} {α}_{s} {V}_{P}^{( s )} + {β}_{t} {δ}^{( t )} ,$$

where V_{C}^{(t)} is the call volume in month t, V_{P}^{(s)} is the sales volume of products sold in months prior to month t, δ^{(t)} represent a product life cycle indicator in month t, C is the intercept term, and αₛ, and βₜ are the corresponding coefficients.
Operation 1403 is executed to identify an upper and lower bound (e.g., collectively a bound) for the long-term product life cycle based forecast, the bound generated using a confidence interval forecast or a manually adjusted range forecast. In some example embodiments, this bound is generated from the long-term trend effect and seasonal effect forecast of FIG. 13. Operation 1404 is executed to adjust the long-term product life cycle effect, where a point (e.g., the new prediction point(s) of FIG. 4) exceeds the upper or lower bound. This adjustment may include transforming the new prediction point(s) to follow the time series points of the upper or lower bound, where the new prediction point(s) exceeds the time series points.

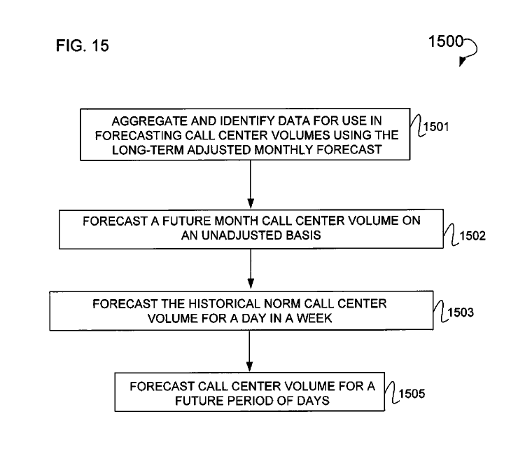

FIG. 15 is a flow chart illustrating an example method 1500 for applying the long-term adjusted monthly forecast based upon some type of time granular basis. The various operations shown herein may be executed in hardware, software, or firmware. Further, these various operations may be executed by one or more of the devices 102, the scheduling server 110, or included in logic encoded on a computer-readable media associated therewith. Additionally, these various operations may be optionally executed. Operation 1501 is executed to aggregate and identify data for use in forecasting call center volume using the long-term adjusted monthly forecast. Operation 1502 is executed to forecast a future monthly call center volume on an unadjusted basis. Operation 1503 is executed to forecast the historical norm call center volume for a day in a week. Operation 1505 is executed to forecast call center volume for a future period of days.

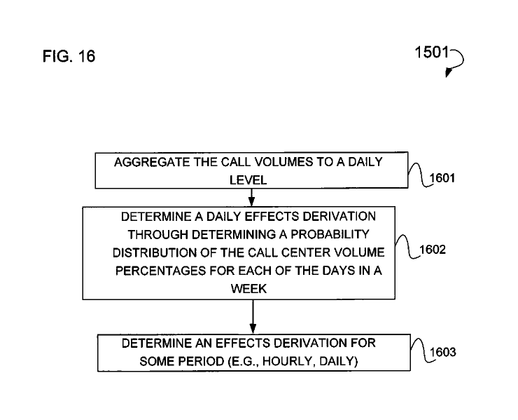

FIG. 16 is a flow chart illustrating an example method 1501 for aggregating and identifying data for use in forecasting call center volumes using the long-term adjusted monthly forecast. Operation 1601 is executed to aggregate the call volumes to a daily level (e.g., daily call center volume). In some example embodiments, call center volumes from a period that makes up a work week is analyzed, where this work week may or may not exclude Saturday and Sunday. Operation 1602 is executed to determine a daily effects derivation. In some example embodiments, the daily effects derivation is a probability distribution of the call center volume percentages for each of the days in a week. For example, the daily call center volume for a work week organized into quartiles computed at levels of 5%, 25%, 50%, 75%, and 95%. Operation 1603 is executed to determine an effects derivation for some period of time. In some example embodiments, a call center volume for a period within a day is derived. This period may be an hour, half hour or some other period in a day. The day may be based upon the above referenced daily effects derivation. In some example embodiments, the period is a portion of an hour, or a fiscal period (e.g., a fiscal quarter).

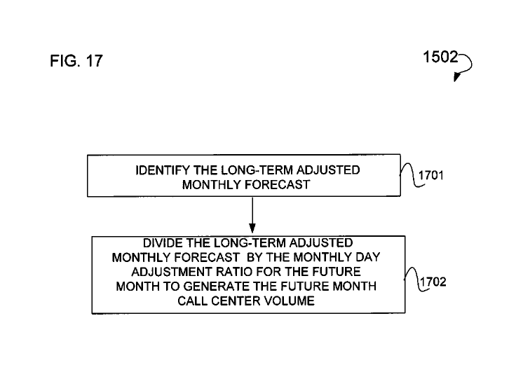

FIG. 17 is a flow chart illustrating an example method 1502 to forecast a future month call center volume on an unadjusted basis. Operation 1701 is executed to identify the long-term adjusted monthly forecast. Operation 1702 is executed to divide the long-term adjusted monthly forecast (see FIG. 14) by the monthly day adjustment ratio (see FIG. 12) for the future month. The resulting quotient is the future month call center volume.

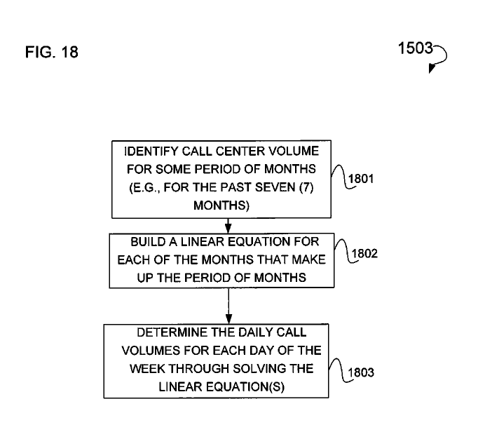

FIG. 18 is a flow chart illustrating an example method 1503 to forecast the historical norm call center volume for a day in a week. Operation 1801 is executed to identify call center volume for some period of months (e.g., for the past seven (7) months). The call volume in a month is represented as M^{(j)}, where j represents each month in the period. Operation 1802 is executed to identify the number of days in each month. The number of effective work days in a month, j, for a particular day of week, d, is represented as N_{d}^{(j)}. Operation 1803 is executed to build a linear equation for each of the months that make up the period of months. For example, if the period is seven months, then seven linear equations may be computed through the execution of operation 1803. Below is provided an example of one of these linear equations:

N₁^{(j)}X₁+N₂^{(j)}X₂+ . . . +N₇^{(j)}X₇=M^{(j)},

where X_{d} is the daily call volume in day d.
Operation 1804 is executed to determine the daily call volumes for each day of the week through solving the above linear equations. This daily call volume for each day of the week solved from the equations can be represented as \hat{X}_{d}. In some example embodiments, ordinary least square regression is used in determining the values for the daily call center volume norms. Further, another method is to pool different but similar days together. For example, pool Monday through Thursday, pool Friday through Sunday.

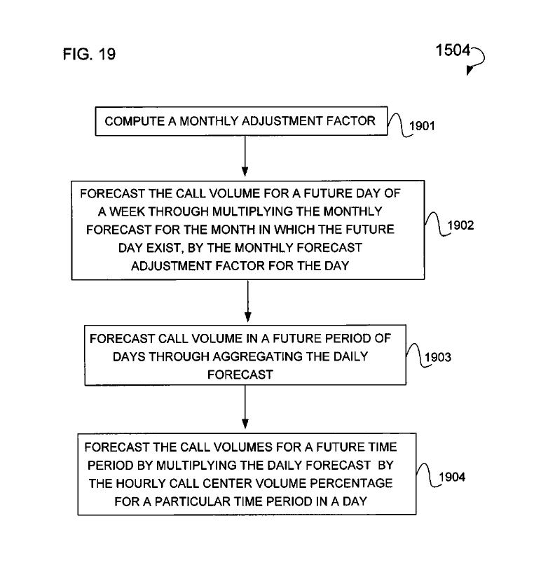

FIG. 19 is a flow chart illustrating an example method 1504 used to forecast call center volume for a future period of days. Shown is an operation 1901 that is executed to compute a monthly adjustment factor. In one example embodiment, for each day of the week, a daily average call volume percentage relative to a monthly total is computed. This daily average call volume percentage is represented as follows:

$${\hat{R}}_{d} = \frac{{\hat{X}}_{d}}{( \frac{1}{7} {\sum }_{j = 1}^{7} {M}^{( j )} )} ,$$

where X_{d} is the daily call center volume norm on day d.
In some example embodiments, a monthly adjustment factor value is determined using the following equation:

$${\hat{R}}_{d} = \frac{( {\sum }_{j = 1}^{7} \frac{{\hat{X}}_{d}}{{M}^{( j )}} )}{7}$$

Operation 1902 is executed to forecast the call volume for a future day of a week through multiplying the monthly forecast \hat{M}^{(j′)} for the month (j′) in which the future day exist, by the monthly forecast adjustment factor for the day. Further, an unadjusted call volume forecast for the future day of the week can be represented as follows:

$${\hat{X}}_{d}^{( {j}^{′} )} = {\hat{M}}^{( {j}^{′} )} {\hat{R}}_{d} = {\hat{M}}^{( {j}^{′} )} \frac{{\hat{X}}_{d}}{\frac{1}{7} {\sum }_{j = 1}^{7} {M}^{( j )}}$$

Operation 1903 is executed to forecast call volume in a future period of days through aggregating the daily forecasts \hat{R}_{d}. This is the unadjusted call volume forecast for the future period of days. Operation 1904 is executed to forecast the call volumes for a future time period by multiplying the daily forecast \hat{X}_{d}^{(j′)} by the hourly call center volume percentage for a particular time period in a day (e.g., 9:00 am through 10:00 am, Oct. 1, 2010).

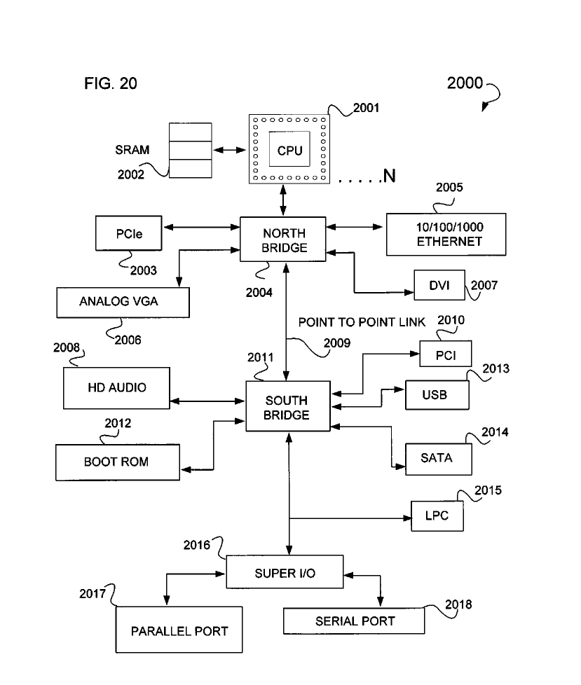

FIG. 20 is a diagram of an example computer system 2000. Shown is a CPU 2001. The processor die 201 may be a CPU 2001. In some example embodiments, a plurality of CPU may be implemented on the computer system 2000 in the form of a plurality of core (e.g., a multi-core computer system), or in some other suitable configuration. Some example CPUs include the x86 series CPU. Operatively connected to the CPU 2001 is Static Random Access Memory (SRAM) 2002. Operatively connected includes a physical or logical connection such as, for example, a point to point connection, an optical connection, a bus connection or some other suitable connection. A North Bridge 2004 is shown, also known as a Memory Controller Hub (MCH), or an Integrated Memory Controller (IMC), that handles communication between the CPU and PCIe, Dynamic Random Access Memory (DRAM), and the South Bridge. A PCIe port 2003 is shown that provides a computer expansion port for connection to graphics cards and associated GPUs. An ethernet port 2005 is shown that is operatively connected to the North Bridge 2004. A Digital Visual Interface (DVI) port 2007 is shown that is operatively connected to the North Bridge 2004. Additionally, an analog Video Graphics Array (VGA) port 2006 is shown that is operatively connected to the North Bridge 2004. Connecting the North Bridge 2004 and the South Bridge 2011 is a point to point link 2009. In some example embodiments, the point to point link 2009 is replaced with one of the above referenced physical or logical connections. A South Bridge 2011, also known as an I/O Controller Hub (ICH) or a Platform Controller Hub (PCH), is also illustrated. Operatively connected to the South Bridge 2011 are a High Definition (HD) audio port 2008, boot RAM port 2012, PCI port 2010, Universal Serial Bus (USB) port 2013, a port for a Serial Advanced Technology Attachment (SATA) 2014, and a port for a Low Pin Count (LPC) bus 2015. Operatively connected to the South Bridge 2011 is a Super Input/Output (I/O) controller 2016 to provide an interface for low-bandwidth devices (e.g., keyboard, mouse, serial ports, parallel ports, disk controllers). Operatively connected to the Super I/O controller 2016 is a parallel port 2017, and a serial port 2018.

The SATA port 2014 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 2002 and/or within the CPU 2001 during execution thereof by the computer system 2000. The instructions may further be transmitted or received over the 10/100/1000 ethernet port 2005, USB port 2013 or some other suitable port illustrated herein.

In some example embodiments, a removable physical storage medium is shown to be a single medium, and the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

In some example embodiments, the methods illustrated herein are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. A computer implemented method comprising:
identifying, using an identification module, adjusted historical monthly call volume data;
transforming, using a forecasting engine, the adjusted historical monthly call volume data, using a forecasting algorithm, into a long-term trend and season effect forecast;
transforming, using a regression engine, the adjusted historical monthly call volume data, using a regression algorithm, into a long-term product life cycle based forecast; and
adjusting, using an adjustment engine, a point prediction, based on the long-term product life cycle based forecast to create a long-term adjusted monthly forecast, the point prediction adjusted where it exceeds a data point in a bound forecast generated from the long-term trend and season effect forecast.

2. The computer implemented method of claim 1, wherein the adjusted historical monthly call volume data is a date data adjusted to exclude call volume data associated with a non-work day.

3. The computer implemented method of claim 1, wherein the forecasting algorithm includes at least one of a Holt-Winters algorithm or an Autoregressive Integrated Moving Average (ARIMA) model.

4. The computer implemented method of claim 3, wherein the transforming of the adjusted historical monthly call volume data, using a regression algorithm, includes a use of at least one of a sales amount for a product, or a life cycle for the product.

5. The computer implemented method of claim 3, wherein the regression algorithm includes at least one of a linear regression algorithm or ordinary least squares regression algorithm.

6. The computer implemented method of claim 1, wherein the bound forecast includes at least one of an upper bound, or lower bound for the long-term product life cycle based forecast.

7. The computer implemented method of claim 6, further comprising generating, using a bounding engine, the upper bound and the lower bound using at least one of a confidence interval forecast, or a manually adjusted range forecast.

8. A computer implemented method comprising:
identifying, using a portion identification engine, a portion of a long-term adjusted monthly forecast based upon a period;
determining, using a derivation engine, a derivation of the long-term adjusted monthly forecast based upon the period; and
generating, using a schedule generation engine, a call center service schedule based upon the derivation of the long-term adjusted monthly forecast based upon the period.

9. The computer implemented method of claim 8, wherein the period includes at least one of a month, a day, an hour, a portion of an hour, or a fiscal period.

10. The computer implemented method of claim 8, wherein the derivation is a probability distribution of call volume percentages for the period.

11. The computer implemented method of claim 8, further comprising forecasting a call volume for the period through dividing the long-term adjusted monthly forecast by a monthly day adjustment ratio for a future period.

12. A computer implemented method comprising:
aggregating, using an aggregation engine, call volume data for a period;
building, using a linear equation engine, a set of linear equations for a portion of the period; and
solving, using a solution engine, the linear equations to get a daily call volume for the portion of the period.

13. The computer implemented method of claim 12, wherein the period includes at least one of a month, a day, an hour, a portion of an hour, or a fiscal period.

14. The computer implemented method of claim 12, wherein the portion of the period includes at least one of a day of a month, or an hour of a day.

15. The computer implemented method of claim 12, wherein the set of linear equations is for a plurality of months for the period.
